(19) United States
(12) Patent Application Publication
(10) Pub. No.: US 2011/0271109 A1
(43) Pub. Date: Nov. 3, 2011

(54) SYSTEMS AND METHODS OF REMOTE DEVICE AUTHENTICATION

(75) Inventors: Troy Schilling, Salt Lake City, UT (US); Sara Mohanty, San Diego, CA (US); Subhashis Mohanty, San Diego, CA (US)

(73) Assignee: TOR ANUMANA, INC., San Diego, CA (US)

(21) Appl. No.: 12/845,803

(22) Filed: Jul. 29, 2010

Related U.S. Application Data
(60) Provisional application No. 61/330,346, filed on May 1, 2010.
(60) Provisional application No. 61/333,251, filed on May 10, 2010.
(60) Provisional application No. 61/333,965, filed on May 12, 2010.
(60) Provisional application No. 61/345,270, filed on May 17, 2010.
(60) Provisional application No. 61/347,350, filed on May 21, 2010.

(51) Int. Cl. G06F 21/20; H04L 9/32

(52) U.S. Cl. 713/168; 726/4

(57) ABSTRACT

Methods and systems are provided herein that allow for a first device to remotely authenticate a particular software or hardware feature of a second device with which the first device is communicating. More specifically, the teachings herein allow for a server to verify that a particular application running on a client machine is an authentic application, as opposed to an application developed by a rogue element disguising itself as a authentic application. In a broader sense the teachings herein allow a server to initiate a sequence of instructions on the remote machine, and for which assurance is needed that the intended instructions were executed on the remote machine. Additionally methods and systems are provided that generate and update client registration certificates that are tightly bound to both client and server.

### CROSS-REFERENCE TO RELATED APPLICATIONS

This application claims priority to U.S. Provisional Application No. 61/330,346 filed on May 10, 2010 entitled Remote Device Authentication; U.S. Provisional Application No. 61/333,251 filed on May 10, 2010 entitled Remote Device Authentication and Tightly Bound Certificates; U.S. Provisional Application No. 61/333,965 filed on May 12, 2010 entitled Remote Device Authentication and Tightly Bound Certificates; U.S. Provisional Application No. 61/345,270 filed on May 17, 2010 entitled Remote Device Authentication and Tightly Bound Certificates; and U.S. Provisional Application No. 61/347,350 filed on May 21, 2010 entitled Remote Device Authentication and Tightly Bound Certificates. All of these provisional applications are expressly incorporated by reference herein in their entireties.

### FIELD OF THE INVENTION

The teachings herein are directed to new methods that enable a first computing device to remotely authenticate a feature in a second remote computing device.

### BACKGROUND

In a computer network operating system, it is oftentimes desirable for one device to verify some feature of the hardware or software on a second device with which the first device is communicating. While preferred embodiments herein are primarily directed to the first device and the second device being different devices such that the first device is the “server” or “local machine” and the second device is the “client” or the “remote machine” it is expressly contemplated herein that the first device and the second device can actually be the same device, such that one part of the device is verifying a feature of another part of the same device. As a non-limiting example, the server may wish to verify that an application executing on a remote device is a genuine application as opposed to a rogue application disguising itself as an authentic application. Advantageously, a communication link allows communication between the first and second device. Any suitable communication link that allows for the transmission and/or receiving of digital information between the first and second device can be used with the teachings herein. For embodiments where the first device is a server or local machine and the second device is a client or a remote machine, the communication link can be a network connection, non-exclusively including wired and wireless communication links. Non-exclusive examples of network communication links can include: Ethernet, wireless LAN, cellular wireless networks, fiber optic, satellite, and the like. For alternative embodiments wherein the first device and the second device are the same device, the communication link can simply be the device's integrated circuitry. Thus, the first and second computing devices in communication with each other can be the same device, client and server, or any other network related devices, non-exclusively including: personal computers, PDAs, phones, mobile computing devices, and the like.

Ideally, the solution to authenticating a remote device software would be for the server, without cooperation from the client, to locate the binary file(s) associated with the application and operating system elements with which it is communicating, read them, and perform bit-for-bit comparisons with the authentic client files. The server would then authenticate the client if the corresponding bit sequences between the located files and the authentic files agree with each other. Unfortunately there are at least two problems with the above solution.

The first problem associated with this solution relates to storage and bandwidth capacity. More specifically, the server may not have sufficient storage for all of the binary files for each version for each client application and operating system components it needs to authenticate. Even if the server has sufficient storage, the nature of the communication channel between the server and client may prohibit transfer of the entire client binary file. The second problem to the proposed solution is that it is generally prohibitive for a remote server to directly interrogate the client without cooperation from the client or the client application.

Based on the above problems, one object of the teachings herein is to provide systems and methods which allow a first device to authenticate a remote second device wherein the first device may have limited storage and/or communicative capacity, and that allow for cooperation between the server and the client or the client application.

### SUMMARY

According to preferred embodiments, the teachings herein include methods of assessing the authenticity of a feature in a second device including: providing a first device having a library of instruction sequence templates, a library of desired computation ingredients, and a library of filler instructions; providing a communication link between the first device and a second device having a feature targeted for authenticity assessment; selecting a instruction template from the library of instruction sequence templates in the first device; selecting a ingredient from the library of desired computation ingredients in the first device; generating a desired computation instruction from the selected ingredient in the first device; selecting a filler instruction from the library of filler instructions in the first device; interleaving the selected instruction template; the generated desired computation instruction; and the selected filler instruction to form a challenge instruction sequence in the first device; transmitting said challenge instruction sequence from the first device through the communication link to the second device; executing the challenge instruction sequence in the second device feature targeted for authenticity assessment to form a response to the challenge instruction; transmitting the second device's response to the challenge instruction back to the first device through the communication link; and assessing the authenticity of the targeted feature in the first device based upon the second device's transmitted response.

According to further preferred embodiments the teachings herein are also directed to systems assessing the authenticity of a targeted feature in a second device including: a first device having a library of instruction sequence templates, a library of desired computation ingredients, and a library of filler instructions; a second device having a feature targeted for authenticity assessment and having a communication link with the first device and; means for selecting a instruction template from the library of instruction sequence templates; means for selecting a ingredient from the library of desired computation ingredients; means for generating a desired computation instruction from the selected ingredient; means for selecting a filler instruction from the library of filler instructions; means for interleaving the selected instruction template; the generated desired computation instruction; and the selected filler instruction to form a challenge instruction sequence; means for transmitting said challenge instruction sequence from the first device through the communication link to the remote client; means for executing the challenge instruction sequence in the second device's feature targeted for authenticity assessment to form a response to the challenge instruction; means for transmitting the second device's response to the challenge instruction back to the first device through the communication link; and means for assessing the authenticity of the targeted feature based upon the second device's transmitted response.

### BRIEF DESCRIPTION OF THE DRAWINGS

FIG. 1 is a flowchart showing a process for remote device authentication.

FIG. 2 is a flowchart showing a process for selecting ingredients.

FIG. 3 is a flowchart showing a process for generating desired computation instructions.

FIG. 4. is a flowchart showing a process for selecting filler instructions.

FIG. 5. is a flowchart showing a process for interleaving instructions.

FIG. 6 is a flowchart showing a process for generating a tightly-bound certificate.

### DETAILED DESCRIPTION OF THE ILLUSTRATED EMBODIMENTS

Embodiments of the present invention are described below. It is, however, expressly noted that the present invention is not limited to these embodiments, but rather the intention is that modifications that are apparent to the person skilled in the art and equivalents thereof are also included.

In general terms, an object of the teachings herein is to provide systems and methods of remote device authentication. More specifically the teachings herein provide systems and methods that allow a first device to verify that an application executing on a remote device is in fact a genuine application. The systems and methods herein make it more difficult for an adversary to obtain data services on an unauthorized client. More specifically, the embodiments herein can increase the level of security that a data service provider can enforce, thereby protecting the data service provider's intellectual property. As one non-limiting example, a data services provider may wish to restrict new multi-media content delivery to particular form-factor devices so as not to cannibalize revenue from existing businesses.

While the teachings herein are primarily directed to the specific problem of remote device authentication, those with skill in the art will readily appreciate that they may also be applied to a broader set of situations. One such situation could be a system and method of assuring that when a server initiates a sequence of instructions on a remote machine, the intended instructions were actually executed, rather than being injected by a user of the remote device. It is additionally noted that while this disclosure is primarily directed to servers and clients, it would be apparent to those skilled in the art that the systems and methods disclosed herein can be applied to any computing device that is in communication with another computing device, non-exclusively including: personal computers, PDAs, phones, mobile computing devices, and the like.

While generally the communication will be an encrypted session, encryption is not a necessary condition for the systems and methods provided herein to be useful. The teachings herein are particularly advantageous when adversarial users of the client, who wish to defeat the system, possess a copy of the authentic client application and have the potential to reverse-engineer and modify an instruction sequence, given sufficient time to do so.

Generally, the teachings herein allow for a server to generate a challenge question that can only be correctly answered by an authentic client. More specific embodiments herein provide methods of generating a computation whose result, if executed and returned by the client, within a predetermined amount of time, indicates that the client is operating an authentic application. The teachings herein ensure with high probability that the client performed the specific computation generated and provided by the server, rather than another computation injected by an adversarial party.

The systems and methods herein address issues of storage and bandwidth capacity as follows. Instead of having the server store the entire binary files for each version for each client application and operating system components desired to be authenticated, a fragmented approach is used instead. More specifically, the server can be configured to store the hash of the application and/or operating system component binaries, along with the hash of some number of segments of the binaries. The hash can be computed using a cryptographic hash function. This can readily be done for each version of each application and operating system component binary of interest. The number of segments can be chosen based on security requirements. This method is particularly advantageous even when adversaries know or have access to which segments are stored, and which hash function is used, and therefore know the hash of each segment. Alternatively, one can use hashes of other quantities of interest on the client device.

The solution to the second problem, that it is generally prohibitive for a remote server to directly interrogate the client without cooperation from the client or the client application, is for the server to dynamically generate, and transmit a challenge to the client. Advantageously, the challenge can be transmitted from the server to the client in the form of machine-level instructions that can be immediately executed by the client application, without human participation. Furthermore, the server can generate a random number or randomly selected file segments, from which the challenge instruction sequence determines the client application or operating system component segments, and calculates the hash of the segments. More generally, one could replace the computation of hashes of segments of the application binary with arbitrary “computation ingredients,” and select a random number of random ingredients to use with the methods herein. Regardless of whether the computation is of hashes of segments or computation ingredients, it is advantageous that the instruction sequence determines the executable file associated with the process that is executing the instructions.

In order to further harden against automated reverse engineering, a correct response from the client is accepted by the server only if it is received within a predetermined amount of time. The time limit is selected based on the complexity of the computation and the nature of the communication channel. This time limit is selected to be smaller than the time required for automated disassembly of the instruction sequence.

Implicit in the problem addressed is the condition that the server is in communication with an application running on the client device. In the context of the processing of the authentication challenge described above, however, the client application is nearly passive, and does not require a human user to receive, process, or return the challenge response. The client application can simply include a user-independent function to receive the challenge instruction sequence, execute it in memory, and return the result.

The embodiments herein are also directed to methods and systems that can generate and update client registration certificates that are tightly bound to both client and server. In general, registration certificates can indicate authorization of a specific client device to perform specific activities with a specific server. The methods and systems provided herein have the following advantages. They are immune to spoofing in the sense that is not possible for an adversarial user of the client device to generate a certificate that appears valid to the server. Additionally the teachings herein are immune to replay in the sense that once a certificate is presented to the server (e.g., for the purpose of initiating a data service session), the certificate becomes invalid for future use. A further advantage is that the systems and methods herein enable the server to verify that a certificate was issued to a particularly assigned client device. Still a further advantage is that the teachings herein allow the server to verify that the server was the originator of the certificate.

### Remote Device Authentication

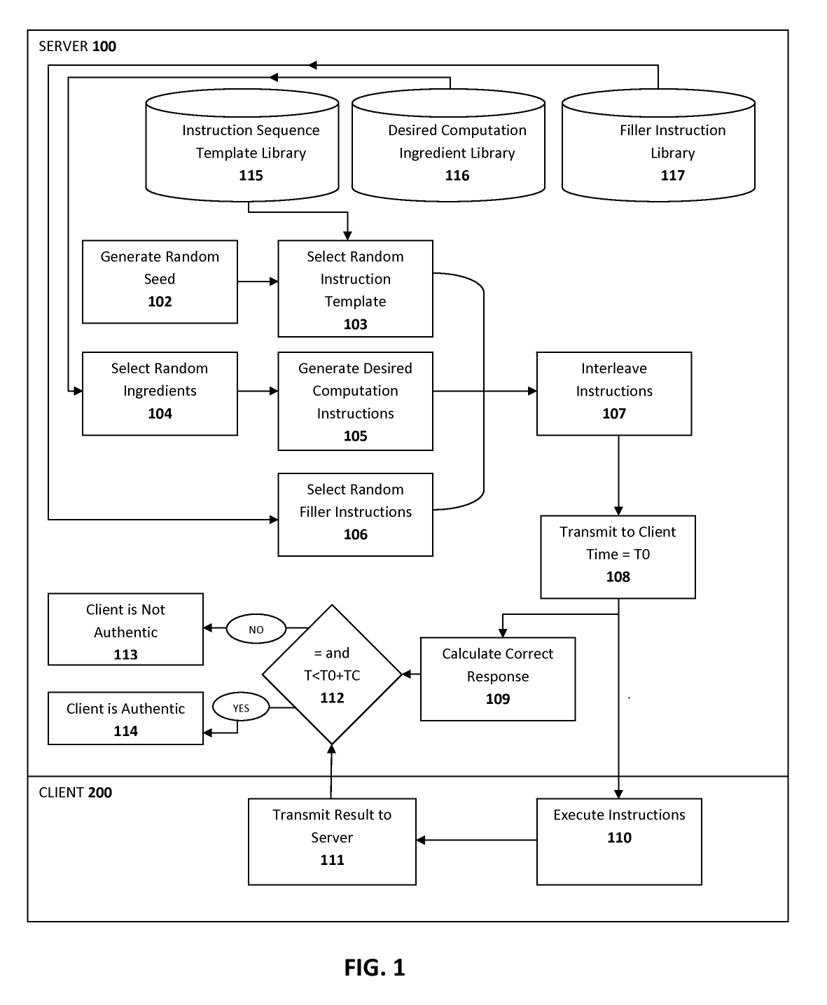

FIG. 1 contains a top-level flow diagram that depicts the overall design and concept of remote authentication. In general terms the system and method involves the server sending a challenge instruction sequence to the client, which immediately, or at least promptly, executes the instructions in memory. The challenge instruction sequence can locate the binary file(s) that contains the executable client application and/or operating system components with which the server is communicating. The challenge instruction sequence can then compute a quantity that depends on the contents of these files in a way that varies from one challenge to the next, and therefore cannot be anticipated by an adversarial user. The computation of random ingredients together results in a combination of random hashes or other ingredients and is termed the “desired computation” herein. The challenge instruction sequence can also advantageously transform the result of the desired computation in a manner that varies from one challenge to the next and therefore cannot be anticipated by an adversarial user. The challenge instruction sequence also incorporates randomness in the locations (in the instruction sequence) at which the above instructions occur.

The description below is directed to an embodiment wherein the server dynamically generates challenge sequences as they are needed. For a variety of reasons, however, challenges, or elements thereof can be chosen before they are actually needed. For example, when the server is in somewhat of an idle state, a challenge sequence can be generated and the results can be saved for future use. A similar approach can be taken for the generation of random numbers consumed by the algorithm.

Each element of the authentication method and system provided in the figures is now described in accordance with its reference number. With respect to FIG. 1, the server 100 advantageously includes each of the following specific library types: a instruction sequence template library 115, a desired computation ingredient library 116 and a filler instruction library 117 each of which will be described in detail below.

### Desired Computation Ingredient Library

The desired computation ingredient library 116 includes ingredients that are available for construction of the desired computation. More specifically, the server 100 can include a single desired computation ingredient library 116 for each authentic client type, or even several for each type of client architecture, with which it is in communication. Each ingredient within the one or more desired computation ingredient libraries 116 is, in general terms, a function that maps a bit stream (application or operating system component binary file), or a segment thereof, associated with the software with which the server is communicating into an array of bits. To generate the desired computation, the server 100 is configured to select one or more random number of ingredients from the desired computation ingredient library 116. The result of the desired computation is dependent upon the result of every individual ingredient computations. According to certain embodiments, the desired computation might be the concatenation of the results of the selected ingredients. As one example, if two ingredients are selected and their results, after acting on the client binary file, are “asdf” and “jk10”, the result of the desired computation would be “asdfjk10”.

Additionally, the desired computation is dependent on all bits comprising the client application binary and/or operating system components to be verified. For example, if hashes of segments of the application binary are used for the desired computation ingredients, one could ensure that one of the ingredients is always the hash of the entire application binary.

The number of ingredients per authentic client type will depend, in part, on the computational resources available to the server, which could be a mobile device, for example. It is anticipated that hundreds of ingredients per client type can potentially be used with the teachings herein. It is noted that the number of possible desired computations increases exponentially with the number of ingredients selected, while the number of operations required to perform the desired computations increases linearly with the number of ingredients.

### Instruction Sequence Template Library

The server 100 is also advantageously equipped with at least one instruction sequence template library 115. The server 100 can advantageously include one instruction sequence template library 115 for each client architecture with which it is capable of communication. For example, the server 100 can include an individual instruction sequence template library 115 for each of the following types of client architecture and operating systems: 32-bit MS-Windows, one for 64-bit MS-Windows, Mac OS X, iOS (iPhone), Google Chrome OS, BlackBerry, etc. In the embodiment described here, each individual instruction sequence template in each instruction sequence template library 115 takes a number as its single argument, and returns a sequence of L bytes, where L depends on the implementation. The number type of the argument depends on the specific implementation such as 32-bit integer, big integer, etc. That is, each instruction sequence template effectively has the signature:

unsigned byte*func(number)

Typically, L will be either: 20, 28, 32, 48 or 64, if a secure hash algorithm is used (SHA-1, SHA-224, SHA-256, SHA-384 or SHA-512, respectively). As stated previously, while a hash function is primarily used to explain the teachings herein, a hash function is expressly not an essential element of the methods and systems herein. If a hash function is used, L is not one of the above values by necessity, as the hash can be truncated if desired. Furthermore, a specific implementation of the invention could utilize an arbitrary hash function.

The following description exemplifies how the computation could include a secure hash algorithm. Each instruction sequence template in each library contains all the logic necessary to define a function that takes a number as input, and calculates a B-bit output number K, where B depends on the implementation. For example, B can be 32 for standard arithmetic; B can be indeterminately large if big integer arithmetic is implemented. As an example, an instruction sequence template can contain all the instructions necessary to take an integer X as input, and calculate K=X^{X}. For the suggested implementation of the invention, the value K will be used to arrive at the key for a keyed hash as described below.

According to certain embodiments, each of these instruction sequence templates declares variables fillerUtility1, fillerUtility2, and fillerUtility3, which are to be used by filler instructions as described below. It is important to note that in additional embodiments, instruction sequence templates can be configured to declare more than three filler utility variables. Advantageously, each instruction sequence template can also be configured to declare a variable S to hold a stream or byte pointer, depending on the client architecture associated with the instructions, and a variable lenS to hold the length of a byte stream to which S will be assigned. It is expressly noted that the instruction sequence templates do not make any assignments to these two variables. S and lenS variables will be used when the template is used to generate the challenge instruction sequence.

After the calculation of K, each instruction sequence template is configured to have instructions that calculate a quantity that depends on both K and the data in the stream S. It is highly preferred that these instructions have the characteristics of a secure hash function. While any suitable secure hash function can be used, it is even more preferred that a secured keyed hash over the message to be stored in S using K as the key. As an example, the keyed hash (HMAC) algorithm can comply with FIPS 198-1, using one of the secure hash algorithms documented in FIPS 180-3. It is to be understood that FIPS 198-1 and FIPS 180-3 are merely exemplary hash algorithms, and that any other suitable hash algorithms can also be used with the teachings herein.

### Filler Instruction Library

The server 100 is also equipped with at least one filler instruction library 117. As with the other libraries described above, the filler instruction library 117 can include one library for each client architecture or operating system (e.g., 32-bit MS-Windows, one for 64-bit MS-Windows, Mac OS X, iOS (iPhone), Google Chrome OS, BlackBerry) with which it expects to communicate. Each filler instruction is a benign instruction that can be inserted into any of the instruction sequence templates at certain locations without changing the basic operation of the instruction sequence. Filler instructions can include variables that are local to the instruction, but do not alter them.

Preferably to each instruction sequence template in each instruction sequence template library 115 can be associated a list of locations in the instruction sequence immediately before which it is possible to insert a “filler instruction.” The insertion of a filler instruction at these locations does not change the logic of the instruction sequence template's operation. Additionally, the filler instruction is only performed once.

Associated with each instruction sequence template in each instruction sequence template library 115 is also a list of locations in the instruction sequence immediately before which it is possible to insert elements or ingredients of the desired computation from the desired computation ingredient library 116. This list would typically comprise all valid filler instruction locations that occur after lenS and S are declared, and before the keyed hash calculation is performed. It is also readily contemplated herein that the one or more instruction sequence template libraries 115 and the one or more filler instruction libraries 117 are configured to be periodically updated.

### Generate Random Seed

The function in step 102 of FIG. 1 is to generate a random number element to be the input to the selected instruction template (which maps a number element to a B-bit quantity K. Advantageously, the systems and methods herein can ensure that the method for random number generation selects a value within the range validity which is dependent on implementation specifics.

### Select Random Instruction Template

In step 103 of FIG. 1, a template is selected at random from the instruction sequence template library 115. According to preferred embodiments, each template in the instruction template library 115 will have the same likelihood of being selected. The selected instruction template is modified by assigning its input variable the random number obtained in step 102.

### Select Random Ingredients

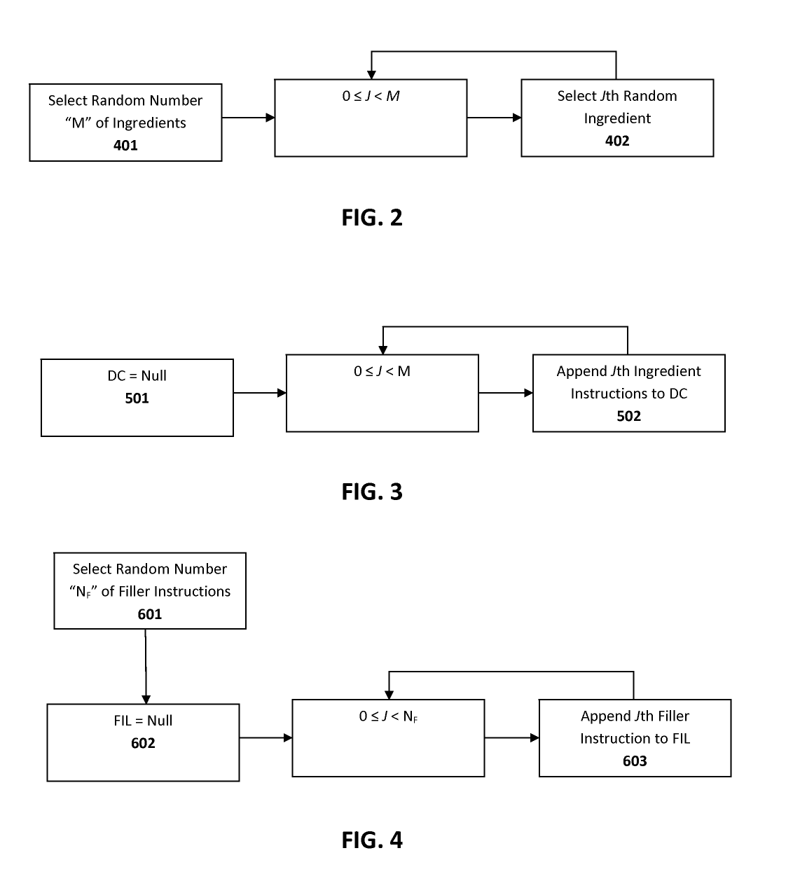

In step 104, a random number of random ingredients can be selected from the desired computation ingredient library 116. Step 104 is shown in more detail in the flow chart of FIG. 2. In step 401a random number of ingredients, M, can be selected. More specifically, this number is the number of ingredients that will comprise the desired computation and the range of possible values of M will be selected based on desired security requirements and computational resources available. Then M additional random numbers are selected, each between 1 and the number of ingredients in the desired computation ingredient library 116. Each of these random numbers determines the selected ingredient. For example, a random draw of a number n results in selection of the nth ingredient. In step 402 in FIG. 2, a Jth random ingredient is also selected wherein J is greater than or equal to 0 and less than M. According to certain embodiments, the selection of ingredients can be performed “with replacement,” meaning that an ingredient can be selected multiple times. According to other embodiments the system can be configured such that an ingredient cannot be selected multiples times.

### Generate Desired Computation Instructions

With respect to step 105, which is shown in more detail in FIG. 3, each ingredient from step 104 is composed of a sequence of instruction blocks, where each block contains an inseparable sequence of instructions. Stated otherwise, interleaving of instructions from two ingredients is not allowed, as such interleaving could change the net result of the individual blocks. Step 501 begins with a Null character as the desired computation has not been formulated. With respect to step 502, the Jth ingredient selected in the step 104 takes the following form:

DCI_BLK_RAND (J, 0): several instructions

DCI_BLK_RAND (J, 1): several more instructions

. . .

DCI_BLK_RAND (J, N_{J}−1): several concluding instructions,

where N_{J} is the number of blocks comprising the Jth computation ingredient.
The desired computation is shown in Table 1.

TABLE 1

| | |
|---|---|
| DC BLK RAND(0) | = DCI BLK RAND(1, 0) |
| DC_BLK_RAND(1) | = DCI_BLK_RAND(1, 1) |
| ... | |
| DC_BLK_RAND(N₁−1) | = DCI_BLK_RAND(1, N₁−1) |
| DC_BLK_RAND(N₁) | = DCI_BLK_RAND(2, 0) |
| DC_BLK_RAND(N₁+1) | = DCI_BLK_RAND(2, 1) |
| ... | |
| DC_BLK_RAND(N_{TOT}−2) | = DCI_BLK_RAND(K, N_{K}−2) |
| DC_BLK_RAND(N_{TOT}−1) | = DCI_BLK_RAND(K, N_{K}−1) |

Here N_{TOT}=N₁+N₂+ . . . +N_{M} is the total number of instruction blocks in all computation ingredients. When these instructions occur in the above order, the instructions comprising any one ingredient are performed before the first instruction of the next selected ingredient. Notably though, other instructions in the template, and filler instructions can be interspersed within an ingredient's instruction blocks. Additionally, the ordering of the instructions comprising an ingredient is preserved.

### Select Random Filler Instructions

In step 106, a random number of random filler instructions can be selected from the filler instruction library 117. More specifically, and as shown in more detail in FIG. 4, a random number, N_{F}, can be selected in step 601. This number is the number of filler instructions to be inserted into the challenge instruction sequence and the range of possible values of N_{F} will be selected based on security requirements and computational resources available. Then N_{F} additional random numbers are selected, each between 1 and the number of filler instructions in the filler instruction library 117. Each of these random numbers determines the selected filler instruction. In step 603 in FIG. 4, a Jth filler instruction is also selected wherein J is greater than or equal to 0 and less than N_{F}. According to certain embodiments the selection of filler instructions is performed “with replacement,” in alternative embodiments the selection is performed without replacement. Table 2 below provides an exemplary order of selected filler instructions.

TABLE 2

FIL INST RAND(0)
FIL_INST_RAND(1)
...
FIL_INST_RAND(N_{F}−1)

### Interleave Instructions

In step 107, the challenge instruction sequence is generated from the instructions in the randomly selected template (step 103), the desired computation instructions (step 105) and the filler instructions (step 106). The challenge instruction sequence calculates a key, based on the randomly selected instruction template (step 103) and the generated random seed (step 102), both of which are selected by the server 100. The challenge instruction sequence can then calculate a keyed hash, over the concatenation of segment hashes, using the key, and using a cryptographic keyed hash function, for example. More generally, one could transform the desired computation in a random manner that could not be anticipated by an adversarial user of the client. This quantity is returned by the challenge instruction sequence.

The challenge instruction sequence can also advantageously include a random number of randomly generated, benign, filler instructions. The instructions that calculate the segment hashes, key computation, the keyed hash, and the filler instructions can then be interleaved in a random manner. The purpose of selecting random segments of the application and/or operating system component binaries (more generally, random ingredients from a library), and a random instruction sequence for key generation (more generally, for transformation of the desired computation), is to ensure that an adversary cannot know (or guess with non-negligible probability) the correct answer to the challenge in advance. All features contribute to hardening against automated disassembly, and modification, of the challenge instruction sequence for the purpose of defeat.

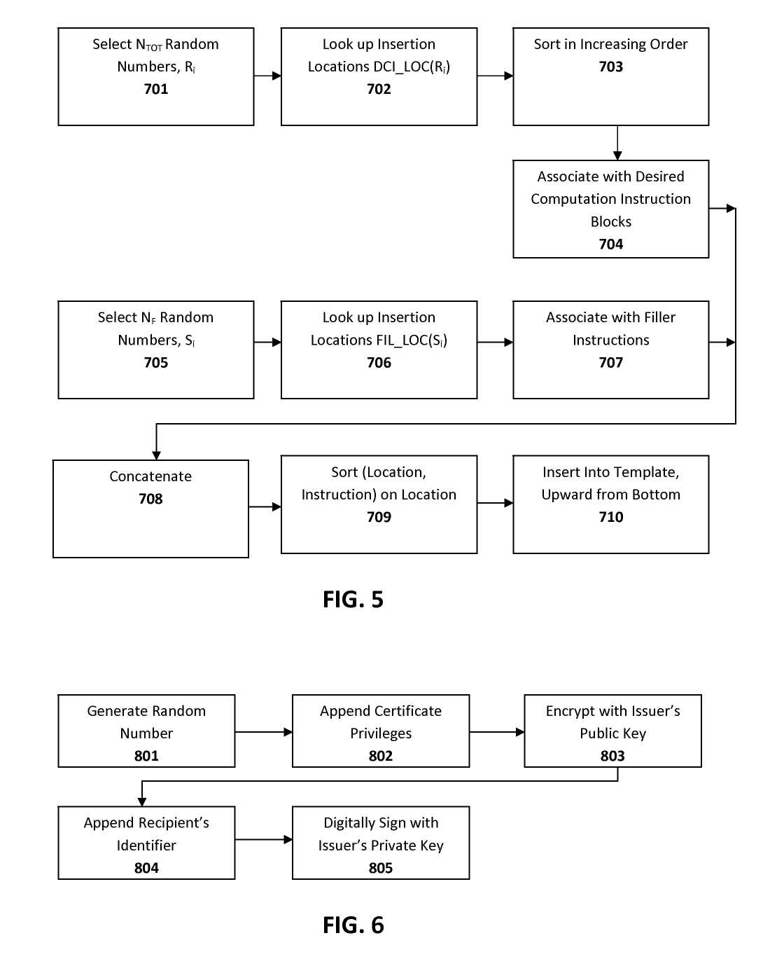

Step 107 is provided in more detail in FIG. 5 and is where these three sets of instructions are interleaved with one another in a random manner. The following describes an exemplary way of performing this step. Each instruction sequence template is associated with two lists, a list of locations immediately before which filler instructions may be inserted, and a list of locations immediately before which desired computation instructions may be inserted. These lists can be denoted respectively as FIL_LOC and DC_LOC. Additionally a length for each list can be denoted as L_{FIL} and L_{DC}, respectively. According to the notation used here, if FIL_LOC(n)=k, where 0≦n<L_{FIL}, then the nth instruction of the template before which it is possible to insert a filler instruction is the kth template instruction. Accordingly, k is always greater than or equal to n.

A random location within the instruction template can be selected for each of the N_{TOT} desired computation instructions, such that the relative ordering of the desired computation instructions is preserved. In step 701, N_{TOT} random numbers between zero and L_{DC}−1, inclusive can be selected. For each of these random numbers, the corresponding available desired computation instruction location in the DC_LOC list can be obtained in step 702. This step results in the generation of a random list of locations in the template into which, one can insert a desired computation instruction. To preserve the relative order of the desired instructions, one can advantageously sort this list of random locations in increasing order in step 703. In step 704, DC_BLK(k) can then be inserted in the kth random location found in this sorted list.

With reference to step 705, the random locations within the instruction template at which each of the N_{F} randomly selected filler instructions can be inserted, can be obtained by generating N_{F} random numbers between 0 and L_{F}−1 inclusive. In step 706, these numbers can then be used as indices to locate the available filler instruction location in the FIL_LOC list. In step 707 the filler instructions are associated with the locations within the template at which the filler instructions are to be inserted. The list of N_{TOT}+N_{F} instructions can be inserted into the template in step 708 at their associated locations just selected. Table 3 below provides locations of instruction insertions.

TABLE 3

| Insertion Location | Instruction |
|---|---|
| DC_LOC_RAND(0) | DC_BLK_RAND(0) |
| DC_LOC_RAND(1) | DC_BLK_RAND(1) |
| ... | ... |
| DC_LOC_RAND(N_{TOT} − 1) | DC_BLK_RAND(N_{TOT} − 1) |
| FIL_LOC_RAND(0) | FIL_INST_RAND(0) |
| FIL_LOC_RAND(1) | FIL_INST_RAND(1) |
| ... | ... |
| FIL_LOC_RAND(N_{F} − 1) | FIL_INST_RAND(N_{F} − 1) |

Note that the insertion locations are not necessarily unique. If two desired computation instruction blocks are to be inserted at the same location, they can advantageously be inserted in the order in which they appear above. The ordering of filler instructions to be inserted at the same location (or the ordering between a filler instruction and a desired computation ingredient block) is preferably arbitrary.

When the instructions are inserted into the template, the locations below the point of insertion “shift downward” and the teachings herein are configured to account for this. With respect to step 709, the rows of Table 3 can be sorted by the first column in such a way that the relative ordering of rows with the same insertion location is preserved by the sort. In step 710, each instruction can be inserted in its associated location, working upward from the bottom of the sorted table. These sorting methods are not considered an essential element of the teachings herein.

Depending on the scope and type of implementation, the above operations can be performed using a high-level programming language and the result can be compiled afterwards. Alternatively, the above operations can be performed using machine language.

Communication with Client

After being generated in step 107, the challenge instruction set can be transmitted from the server 100 to the client 200 as indicated in step 108. Advantageously, during step 108, the server 100 can record the time of transmission in order to measure the time of response from the client 200 against a predetermined time frame for response. In order to further harden against automated reverse engineering, a correct response from the client is accepted by the server only if it is received within a predetermined amount of time. The predetermined time frame for response can be based on the complexity of the challenge instruction, the nature of the communication channel, and the architecture of the client 200, amongst other factors. Advantageously, this time limit is selected to be smaller than the time required for automated disassembly of the instruction sequence.

After transmitting the challenge instruction sequence to the client 200 in step 108, the server 100 can perform the correct challenge calculation as indicated in step 109. The result calculated by the server 100 is the value corresponding to client authenticity. With respect to step 110, upon receipt of the challenge instruction sequence, the client 200 executes the instructions in memory. In the context of the processing of the authentication challenge described above, the client application is nearly passive, and does not require a human user to receive, process, or return the challenge response. All that must be included in the client application is a user-independent function to receive the challenge instruction sequence, execute it in memory, and return the result back to the server 100 in step 111.

With respect to step 112, upon receipt of the challenge response, the server 100 compares the response to the value calculated by the server 100 in step 109, and determines the time since the challenge was issued to the client 200 based upon the time recorded when the challenge was submitted in step 108. With reference to step 112, the transmitted response from the client 200 is compared to the calculated correct response obtained in step 109. Additionally in step 112, the time it took the client 200 to respond to the challenge instruction set is compared to the established time limit for obtaining the response. With respect to step 113, if the response does not agree with the calculated correct response, or was not obtained within the predetermined time, the server 100 does not authenticate the client 200. Conversely, if the response value and the calculated correct response value agree, and if the response was obtained within the predetermined time, the server 100 authenticates the client 200 in step 114.

### Tightly-Bound Certificates

Embodiments herein directed to the problems associated with tightly bound certificates involve the use of public key cryptography. Certificate generation can begin by having the server generate a random quantity and combine it with whatever client privileges are to be associated with the certificate. This information is then encrypted with the server's public key. The encrypted result is then concatenated with information specifying the client device (e.g., the client's MAC address). The latter result is then digitally signed using the server's private key.

FIG. 6 provides a specific flowchart for generating tightly bound certificates between a server and client. In step 801 the server generates a random number. In step 802 the random number is combined with whatever client privileges are to be associated with the certificate. With respect to step 803, the combination that includes the random number and the client privileges is encrypted with the server's public key. The encrypted result is then concatenated with information specifying the client device (e.g., the client's MAC address) in step 804. In step 805, the concatenated result is then digitally signed using the server's private key. The random quantity encrypted in the inner payload of the certificate can be maintained by the server for future verification of the certificate. If, upon presentation to the server, the certificate is immediately revoked and replaced with another, the certification process is immune to replay or sharing.

### Example

The following section provides an example of the above described steps and is expressly a non-exclusive method. The desired computation ingredient library associated with the client type (hardware+client software version) contains ten (10) desired computation ingredients, the instruction sequence template library contains five (5) instruction sequence templates, and the filler instruction library includes three (3) filler instructions for the client architecture with which it is communicating. Three filler instructions are generated and shown in Table 4 below

TABLE 4

Filler Instruction(0): fillerUtility1 = 2;
Filler_Instruction(1): fillerUtility3 = 7;
Filler_Instruction(2): fillerUtility2 = 2 * fillerUtility2;

The list of filler instructions are indexed beginning at zero to simplify selection of filler instructions based on modulo-n arithmetic, where n is the number of filler instructions. Each desired computation ingredient calculates a hash of a segment of the client application binary currently executing on the client, and concatenates the result with the contents of S. Each ingredient is broken into the following three instruction blocks:
DCI_BLK (I, 1): make system calls to determine file location of currently executing application
DCI_BLK (I, 2): read U(I) bytes from binary file, beginning at offset V(I)
DCI_BLK (I, 3): S={S∥hash of binary file segment}

The character ‘I’ is an index for the list of ingredients. For example, DCI_BLK(I, j) is the jth block of the Ith ingredient. U(I) and V(I) are constants that appear in block 1 of the Ith ingredient and do not represent function calls.

In addition to the 10 desired computation ingredients mentioned above, there is another computation ingredient, whose index is denoted by the symbol ∞ that is specified by the instruction blocks:
DCI_BLK (∞, 1): make system calls to determine file location of currently executing application
DCI_BLK (∞, 2): read the entire application binary file
DCI_BLK (∞, 3): S={S∥hash of binary entire file}

The ∞ ingredient is treated differently from the other ingredients because it will be included in all desired computations as the desired computation depends on every bit in the application binary file. For simplicity, this example includes only hashes of the client application binary. A solution that is more robust to operating system attacks could include information about other aspects of the client. For example, if the client application is running on a Java Virtual Machine, hashes of segments of the virtual machine and/or the associated run-time library can be included. If security requirements dictate, one might also include hashes of operating system files.

A random seed number 1127 is generated by the server. As the instruction sequence template library consists of five instruction sequence templates, a random number between zero and 4 is also selected. The random template number generated is 3 and thus the third instruction sequence template, the fourth in a set indexed from zero, is selected. The instruction sequence template selected is as provided in Table 5 below. The example is provided with a high-level description for clarity, those with skill in the art could alternatively use machine or assembly language.

TABLE 5

| | |
|---|---|
| INSTR 1. | int fillerUtility1=0; |
| INSTR 2. | int fillerUtility2=0; |
| INSTR 3. | int fillerUtility3=0; |
| INSTR 4. | int lenS =0; |
| INSTR 5. | byte* S = 0; |
| INSTR 6. | float L = 0; |
| INSTR 7. | int j = 0; |
| INSTR 8. | int K = 1; |
| INSTR 9. | K = log( X ); |
| INSTR 10. | do while j < (int) L |

| | |
|---|---|
| INSTR 11. | { K = K * L; } |

| | |
|---|---|
| INSTR 12. | RESULT = KeyedHash( key=K, data=S ); // several |
| | instructions |
| INSTR 13. | return RESULT; |

In Table 5 above, X denotes the argument of the instruction sequence, for which the random seed 1127 number is used. Each template is associated with a list of locations immediately before which filler instructions can be inserted. For the above instruction template, a list of available locations for filler instructions is provided in Table 6 below.

TABLE 6

| | |
|---|---|
| FIL LOC 0. | INSTR 4 |
| FIL_LOC 1. | INSTR 5 |
| FIL_LOC 2. | INSTR 6 |
| FIL_LOC 3. | INSTR 7 |
| FIL_LOC 4. | INSTR 8 |
| FIL_LOC 5. | INSTR 9 |
| FIL_LOC 6. | INSTR 10 |
| FIL_LOC 7. | INSTR 12 |
| FIL_LOC 8. | INSTR 13 |

Similarly, the list of available locations for insertion of the desired computation ingredient blocks is provided below in Table 7 below.

TABLE 7

| | |
|---|---|
| DCI LOC 0. | INSTR 6 |
| DCI_LOC 1. | INSTR 7 |
| DCI_LOC 2. | INSTR 8 |
| DCI_LOC 3. | INSTR 9 |
| DCI_LOC 4. | INSTR 10 |
| DCI_LOC 5. | INSTR 12 |

Based on security requirements, the number of ingredients selected for the desired computation is between one (1) and ten (10). A random number between 1 and 10, inclusive, is thus drawn for the number of ingredients in the desired computation. This random number selection results in two (2) ingredients. Then two additional random numbers are drawn to determine which specific random ingredients are selected. Since there are 10 ingredients in the library, the random numbers generated for this purpose are between zero (0) and nine (9), inclusive. The two random numbers 3 and 0 are drawn. This results in the selection of Ingredient(3) and Ingredient(0), respectively.

The desired computation depends on every bit of the application binary. For this reason, the additional ingredient indexed with the symbol ∞, which calculates the hash of the entire binary, is always added to the list of randomly selected ingredients. The position of ∞ within the list of ingredients is chosen at random. In general, if M ingredients are selected, there are M+1 positions, within the list of ingredients, for the ∞ ingredient. The position of ∞ is determined by selecting a random number between 0 and M, inclusive. In this example M=2, so a random number between 0 and 2, inclusive, is selected. The random draw results in the number 1 being selected. This puts the co ingredient between the two selected. The desired computation will then be comprised of the following instruction blocks in the order provided in Table 8 below.

TABLE 8
DC BLK RAND(0) = DCI BLK RAND(3, 1): find application
binary
DC_BLK_RAND(1) = DCI_BLK_RAND(3, 2): read segment #3
DC_BLK_RAND(2) = DCI_BLK_RAND(3, 3): set S =
{S ∥hash of segment #3}
DC_BLK_RAND(3) = DCI_BLK_RAND(∞, 1): find application
binary
DC_BLK_RAND(4) = DCI_BLK_RAND(∞, 2): read entire binary
DC_BLK_RAND(5) = DCI_BLK_RAND(∞, 3): set S =
{S ∥hash of entire binary}
DC_BLK_RAND(6) = DCI_BLK_RAND(0, 1): find application
binary
DC_BLK_RAND(7) = DCI_BLK_RAND(0, 2): read segment #0
DC_BLK_RAND(8) = DCI_BLK_RAND(0, 3)L set S =
{S ∥hash of segment #0}

At this point in the Example, the instruction blocks and their relative ordering, comprising the desired computation have been established, but not the locations at which they will appear in the challenge instruction sequence. The selection of random filler instructions is carried out next. In this example, the number of filler instructions is to be between one (1) and fifteen (15). A random number between 1 and 15, inclusive, is thus generated to establish the number of filler instructions. This random number selection results in two (2). Accordingly, two (2) additional random numbers are drawn to determine the filler instructions. As there are 3 filler instructions in the library, the random numbers generated for this purpose are between zero (0) and two (2), inclusive. In this example the random numbers 2 and 1 are drawn. From Table 4 this random number generation results in the selection of the following two filler instructions in the order provided in Table 9 below.

TABLE 9

| | |
|---|---|
| FIL_INST_RAND(0)=Filler_Instruction(2): | fillerUtility2 = |
| | 2 * fillerUtility2; |
| FIL_INST_RAND(1)=Filler_Instruction(1): | fillerUtility3 = 7; |

Accordingly, the filler instructions and their relative ordering have been established, but not the locations at which they will appear in the challenge instruction sequence. The next step in this Example is to interleave the three sets of instructions: the instruction template, the desired computation instructions, and the filler instructions. As there are nine desired computation blocks in Table 8, nine random numbers between 0 and 5, inclusive (see Table 7) are generated to determine the locations at which desired computation blocks will be inserted into the template. This step results in the generation of the following random numbers:

(0, 4, 3, 1, 5, 2, 0, 3, 2).
From Table 7, these indices correspond to the following instruction locations in the template:

### (INSTR 6, INSTR 10, INSTR 9, INSTR 7, INSTR 12, INSTR 8, INSTR 6, INSTR 9, INSTR 8)

This list of instruction locations is then sorted to obtain:

### (INSTR 6, INSTR 6, INSTR 7, INSTR 8, INSTR 8, INSTR 9, INSTR 9, INSTR 10, INSTR 12).

This result defines the insertion points for the desired computation instruction blocks which are provided in Table 10 below.

TABLE 10

| Insertion Location | Instruction |
|---|---|
| DC_LOC_RAND(0)=INSTR 6 | DC_BLK_RAND(0):findapplication binary |
| DC_LOC_RAND(1)=INSTR 6 | DC_BLK_RAND(1): read segment #3 |
| DC_LOC_RAND(2)=INSTR 7 | DC_BLK_RAND(2): S={S \|\| hash of segment #3} |
| DC_LOC_RAND(3)=INSTR 8 | DC_BLK_RAND(3): find application binary |
| DC_LOC_RAND(4)=INSTR 8 | DC_BLK_RAND(4): read entire binary |
| DC_LOC_RAND(5)=INSTR 9 | DC_BLK_RAND(5): S={S \|\| hash of entire binary} |
| DC_LOC_RAND(6)=INSTR 9 | DC_BLK_RAND(6): find application binary |
| DC_LOC_RAND(7)=INSTR 10 | DC_BLK_RAND(7): read segment #0 |
| DC_LOC_RAND(8)=INSTR 12 | DC_BLK_RAND(8): S={S \|\| hash of segment #0} |

Since two filler instructions were selected, two random numbers between 0 and 8, inclusive (see Table 6), are selected to determine the locations at which the filler instructions will be inserted into the template. This selection results in the following random numbers: (8, 2). These two numbers determine, through reference to Table 6, the locations at which the filler instructions will be inserted. The instruction blocks of Table 10 are updated with the filler instructions in Table 11 below.

TABLE 11

| Insertion Location | Instruction |
|---|---|
| DC_LOC_RAND(0) =INSTR 6 | DC_BLK_RAND(0):find application binary |
| DC_LOC_RAND(1) =INSTR 6 | DC_BLK_RAND(1): read segment #3 |
| DC_LOC_RAND(2) =INSTR 7 | DC_BLK_RAND(2): S={S \|\| hash of segment #3} |
| DC_LOC_RAND(3) =INSTR 8 | DC_BLK_RAND(3): find application binary |
| DC_LOC_RAND(4) =INSTR 8 | DC_BLK_RAND(4): read entire binary |
| DC_LOC_RAND(5) =INSTR 9 | DC_BLK_RAND(5): S={S \|\| hash of entire binary} |
| DC_LOC_RAND(6) =INSTR 9 | DC_BLK_RAND(6): find application binary |
| DC_LOC_RAND(7) =INSTR 10 | DC_BLK_RAND(7): read segment #0 |
| DC_LOC_RAND(8) =INSTR 12 | DC_BLK_RAND(8): S={S \|\| hash of segment #0} |
| FIL_LOC_RAND(0)=INSTR 13 | FIL_INST_RAND(0): fillerUtility2 = 2*fillerUtility2 |
| FIL_LOC_RAND(1)=INSTR 6 | FIL_INST_RAND(1): fillerUtility3 = 7 |

After the rows of Table 11 are sorted in order of increasing instruction location (first column), each instruction is inserted into the template in the location identified in the first column. If insertions are performed as one works upward from the last row of the table, previous insertions will not affect the insertion location, relative to the beginning of the instruction sequence, of future insertions. After inserting filler instructions, the final challenge instruction sequence is provided below in Table 12.

TABLE 12

| | |
|---|---|
| INSTR 1. | int fillerUtility1=0; |
| INSTR 2. | int fillerUtility2=0; |
| INSTR 3. | int fillerUtility3=0; |
| INSTR 4. | int lenS =0; |
| INSTR 5. | byte* S = 0; |
| INSTR 6. | find application binary |
| INSTR 7. | read segment #3 |
| INSTR 8. | fillerUtility3 = 7; |
| INSTR 9. | float L = 0; |
| INSTR 10. | S = { S \|\| hash of segment #3 } |
| INSTR 11. | int j = 0; |
| INSTR 12. | find application binary |
| INSTR 13. | read entire binary |
| INSTR 14. | int K = 1; |

INSTR 15.S = { S || hash of entire binary }

| | |
|---|---|
| INSTR 16. | find application binary |
| INSTR 17. | L = log( X ); |

INSTR 18.read segment #0

| | |
|---|---|
| INSTR 19. | do while j < (int) L |

| | |
|---|---|
| INSTR 20. | { K = K * L; } |

INSTR 21.S = { S || hash of segment #0 }

| | |
|---|---|
| INSTR 22. | RESULT = KeyedHash( key=K, data=S ); // several |
| | instructions |
| INSTR 23. | fillerUtility2 = 2 * fillerUtility2; |
| INSTR 24. | return RESULT; |

The generated challenge instruction is then transmitted from the server to the client. The server records the time of transmission in order to measure the time of response from the client. After transmitting the challenge instruction sequence to the client, the server performs the correct challenge calculation. The result calculated by the server is the value corresponding to client authenticity. Upon receipt of the challenge instruction sequence, the client executes the instructions in memory.

After executing the challenge instructions, the client transmits the result to the server. Upon receipt of the challenge response, the server compares the response to the value calculated by the server and determines the time since the challenge was issued to the client based upon the time recorded when the challenge was transmitted. If the response does not agree with the calculated correct response, or was not obtained within the predetermined time, the server does not authenticate the client. Conversely, if the response value and the calculated correct response value agree, and if the response was obtained within the predetermined time, the server authenticates the client.

The invention may be embodied in other specific forms besides and beyond those described herein. The foregoing embodiments are therefore to be considered in all respects illustrative rather than limiting, and the scope of the invention is defined and limited only by the appended claims and their equivalents, rather than by the foregoing description.

1-38. (canceled)

39. A method of assessing the authenticity of a feature in a second device, wherein the second device comprises a feature targeted for authenticity assessment, the method comprising:
a) providing a first device having a library of computation ingredients, wherein each computation ingredient computes a quantity dependent on the feature targeted for authenticity assessment;
b) providing a communication link between the first device and a second device;
c) selecting at least one ingredient from the library of computation ingredients;
d) forming a challenge instruction based on the selected ingredient;
e) transmitting the challenge instruction from the first device through the communication link to the second device;
f) executing the challenge instruction in the second device;
g) transmitting the second device's response to the challenge instruction back to the first device through the communication link; and
h) assessing the authenticity of the targeted feature based upon the second device's transmitted response.

40. The method of claim 39, wherein the first devices comprises a library of instruction sequence templates and a library of filler instructions, the method further comprising:
selecting an instruction template from the library of instruction sequence templates;
selecting at least one filler instruction from the library of filler instructions; and
wherein step (d) further comprises interleaving the selected instruction template;
the selected ingredient; and the selected filler instruction to form the challenge instruction;

41. The method of claim 39 wherein step (c) is done at random.

42. The method of claim 40 wherein at least one of the following is done at random: one of the selection steps or the formation of the challenge instruction step.

43. The method of claim 39 wherein the targeted feature is selected from the group consisting of: hardware, operating system software, and software applications.

44. The method of claim 39 wherein a computation ingredient determines one or more of: files associated with the targeted second device's software, random access memory (RAM) contents, virtual memory contents, number and state of threads, child processes, file descriptors, network ports, and other runtime variables;

45. The method of claim 39, wherein the library of computation ingredients comprises hashes of the second device's targeted software binaries or segments thereof, wherein the hash operation is selected from a group consisting of: hashes, key hashes and combinations thereof.

46. The method of claim 40 wherein the instruction template computes a hash of a quantity dependent on the computation ingredients, wherein the hash operation is selected from a group consisting of: hashes, key hashes and combinations thereof.

47. The method of claim 39, wherein assessing the authenticity of the targeted feature comprises an evaluation of the validity of the second device's response to the challenge instruction and the time it took the second device to compute the response to the challenge.

48. The method of claim 39, wherein the first device and the second device are different devices.

49. The method of claim 48, wherein the communication link is a network connection

50. The method of claim 39, wherein the first device and the second device are the same device.

51. A system of assessing the authenticity of a feature in a second device, wherein the second device comprising a feature targeted for authenticity assessment, the system comprising:
providing a first device having a library of computation ingredients, wherein each computation ingredient computes a quantity dependent on the feature targeted for authenticity assessment, and a communication link with the second device;
means for selecting at least one ingredient from the library of computation ingredients;
means for forming a challenge instruction based on the selected ingredient;
means for transmitting the challenge instruction from the first device through the communication link to the second device;
means for executing the challenge instruction in the second device;
means for transmitting the second device's response to the challenge instruction back to the first device through the communication link; and
means for assessing the authenticity of the targeted feature based upon the second device's transmitted response.

52. The system of claim 51, wherein the first device comprises a library of instruction sequence templates and a library of filler instructions, the system further comprising:
means for selecting an instruction template from the library of instruction sequence templates;
means for selecting at least one filler instruction from the library of filler instructions;
wherein the means for forming a challenge instruction further comprises a means for interleaving the selected instruction template; the selected ingredient;
and the selected filler instruction to form the challenge instruction sequence.

53. The system of claim 51, wherein the means for selection is done at random.

54. The system of claim 52, wherein at least the means for selection or the means for forming the challenge instruction is done at random.

55. The system of claim 51, wherein the targeted feature is selected from the group consisting of: hardware, operating system software, and software applications.

56. The system of claim 51, wherein a computation ingredient determines one or more of: files associated with the targeted second device's software, random access memory (RAM) contents, virtual memory contents, number and state of threads, child processes, file descriptors, network ports, and other runtime variables;

57. The system of claim 51, wherein the library of computation ingredients comprises hashes of the second device's targeted software binaries or segments thereof, wherein the hash operation is selected from a group consisting of: hashes, key hashes and combinations thereof.

58. The system of claim 52, wherein the instruction template computes a hash of a quantity dependent on the computation ingredients, wherein the hash operation is selected from a group consisting of: hashes, key hashes and combinations thereof.

59. The system of claim 51, wherein the means for assessing the authenticity of the targeted feature evaluates of the validity of the second device's response to the challenge instruction and the time it took the second device to compute the response to the challenge.

60. The system of claim 51, wherein the first device and the second device are different devices.

61. The system of claim 51, wherein the communication link is a network connection.

62. The system of claim 51, wherein the first device and the second device are the same device.
